(19) United States
(12) Patent Application Publication
(10) Pub. No.: US 2002/0198815 A1
(43) Pub. Date: Dec. 26, 2002

(54) System and process for providing institutional directed sponsored trading

(76) Inventors: Robert Greifeld, Westfield, NJ (US); Brian K. Hyndman, New York, NY (US); Richard D. Schenkman, Tenafly, NJ (US)

Correspondence Address: Ted R. Rittmaster, FOLEY & LARDNER, Suite 3500, 2029 Century Park East, Los Angeles, CA, 90067-3021, US

(21) Appl. No.: 09/893,330

(22) Filed: Jun. 26, 2001

(51) Int. Cl. G06F 17/60

(52) U.S. Cl. 705/37

(57) ABSTRACT

An Institution wishing to trade securities may connect to an Electronic Communication Network through a network interface. The Institution may then enter orders to buy and sell securities, display such orders to all subscribers to the system, and automatically match and execute the orders. The Institution may designate a broker to sponsor a particular trade or group of trades. The execution of these orders and other trade-related services are provided to the Institution by the Electronic Communication Network operator. The Institution pays commissions to the Electronic Communication Network operator for trade executions. The Electronic Communication Network operator then reports to the sponsoring brokers the identity of the designating Institutions and the sponsored trading activities executed by the Electronic Communication Network operator for the designating Institutions. The Electronic Communication Network operator also pays a portion of the commission for the sponsored trades to the sponsoring brokers.

### BACKGROUND OF THE INVENTION

1. Field of the Invention

Embodiments of the present invention relate to electronic communication networks utilized for securities trading, and more specifically to systems and methods which allow institutional customers trading securities through an electronic communication network to designate a sponsoring broker for specified trading activities.

2. Description of Related Art

Markets have existed for centuries which allow people to buy and sell securities (e.g., stocks, futures, options, commodities, etc.) from one another. Today, examples of these markets in the United States are: The New York Stock Exchange (NYSE), The National Association of Security Dealers Automated Quotation (NASDAQ) System, and The American Stock Exchange (AMEX). These modern security exchanges facilitate the exchange of over two billion shares of stock every business day.

A significant portion of this trading is initiated, either directly or indirectly, by institutional customers (“Institutions”) such as mutual funds, banks, insurance companies, asset managers, pension plans, hedge funds, and the like. Traditionally, these Institutions could not trade securities directly on the above mentioned exchanges. Instead, if an Institution wished to buy or sell stock or other securities, they had to place their orders through a brokerage firm or a broker-dealer (“broker”). The broker executed an Institution's order to buy or sell a security and generated income by charging a commission for executing the Institution's order. Depending on the broker, this commission varied with the number of shares traded. For example, a broker may have charged a base rate of $50.00 to execute a trade, plus an-additional 5 cents per share for every share traded. In return for the payment of a commission, the broker provided to the Institution not only trade-related services such as order execution, but also non trade-related services such as research, opportunities to participate in initial public offerings (“IPOs”), willingness to commit capital for block trades, custodial services, and asset servicing (i.e., services that are provided in relation to tender offers, stock splits, and other corporate action events).

Today, businesses that operate Electronic Communication Networks (“ECNs”), referred to in the present disclosure as “ECN operators,” compete with brokers for securities order flow from Institutions. ECNs are computerized systems that, depending on the functionality provided by the particular ECN, allow for the entry, cancellation, and modification of orders to buy and sell securities, display such orders to all users of the system (“subscribers”) and to other buyers and sellers market-wide, view consolidated market-wide order information, and may allow for the automatic matching and execution of such orders between buyers and sellers within the ECN (“order matching”) and market-wide (“order routing”).

Thus, an Institution who subscribes to an ECN may be able to advantageously enter orders directly, view other parties' orders directly, and route to execute against other parties' orders directly, anonymously, and without the assistance of a broker. ECNs generally charge a commission for executing the Institution's order that is lower than that charged by a traditional broker.

As a consequence of the advent of ECNs, traditional brokers have seen commission revenues from Institutions decrease. Because the non trade-related services provided to the Institutions by the broker typically are, at least in part, paid for by commissions received by the broker, a reduction in commission revenue may result in a corresponding reduction in the quality of non trade-related services that are provided. Thus, the advantages to the Institutions of directly trading through the ECN instead of through the traditional broker are offset by the reduction in the quality of non trade-related services provided to the Institutions by the traditional broker.

Some ECN operators have attempted to duplicate the non trade- related services offered by a traditional broker. These ECN operators provide these services to an Institution as an inducement to increased trading activities by the Institution through the ECN. However, the cost of duplicating and providing such non trade-related services may often be prohibitive for the ECN operator, who is in competition with the traditional broker for the business from the Institutions.

### SUMMARY OF THE INVENTION

Therefore, embodiments of the present invention relate to systems and processes whereby an Institution is provided with the advantages that access to an ECN provides, such as direct entry of orders to buy and sell securities, anonymous order display, and order routing, while at the same time receiving quality non trade-related services, such as securities research, opportunity to participate in IPOs, willingness to commit capital for block trades, custodial services, and asset servicing, that are provided by a traditional broker.

Further embodiments of the present invention relate to systems and processes whereby a traditional broker is provided with the advantages of being designated as a sponsor for an Institution's trading activities that are executed by an ECN operator, the sponsoring broker receiving a portion of a commission paid to the ECN operator by the designating Institution for non trade-related services.

Further embodiments of the present invention relate to systems and processes whereby an ECN operator is provided with the advantages of increased usage of the ECN for trading activities by Institutions that might otherwise use traditional brokers for their trades in order to avoid a decrease in non trade-related services provided to the Institutions by the brokers.

According to a preferred embodiment, an Institution who wishes to trade securities may connect to the ECN through a network interface. The Institution may then enter orders to buy and sell securities, display such orders to all subscribers on the system and to other buyers and sellers market-wide, and automatically match and execute the orders. The Institution may designate a broker to sponsor a particular trade or group of trades.

In some preferred embodiments, an Institution may designate a first broker to sponsor a particular percentage of the Institution's trades and may designate a second broker as sponsor for the remaining percentage. For example, the Institution may designate broker “A” as sponsor for sixty percent of the Institution's trades during a particular trading day. The Institution may then designate broker “B” as sponsor for the remaining forty percent of the Institution's trades during the same trading day.

The execution of these orders and other trade-related services may be provided to the Institution by the ECN operator. The Institution may pay commissions to the ECN operator for trade executions. The ECN operator may then report to the sponsoring brokers the identity of the designating Institutions and the sponsored trading activities executed by the ECN operator for the designating Institutions. The ECN operator may pay a portion of the commission for the sponsored trades to the sponsoring brokers.

These and other advantages are accomplished according to systems and methods for providing institutional sponsorship for securities trading.

### BRIEF DESCRIPTION OF THE DRAWINGS

Embodiments of the present invention are illustrated by way of example, and not by way of limitation, in the figures of the accompanying drawings and in which:

FIG. 1 illustrates a simplified diagram of an exemplary ECN client-server environment in which embodiments of the present invention may be implemented;

FIG. 2 illustrates a client main screen in an ECN support application, in which embodiments of the present invention may be implemented;

FIG. 3 illustrates a desk support main screen in an ECN support application, in which embodiments of the present invention may be implemented;

FIG. 4 illustrates a desk support screen displaying a client's blotter window in an ECN support application, in which embodiments of the present invention may be implemented;

FIG. 5 illustrates a desk support screen displaying two of a client's blotter windows in an ECN support application, in which embodiments of the present invention may be implemented;

FIG. 6 shows a flowchart of a process according to a preferred embodiment of the present invention;

FIG. 7 illustrates an alternative exemplary client main screen in an ECN support application in which embodiments of the present invention may be implemented;

FIG. 8 illustrates an alternative exemplary desk support main screen in an ECN support application in which embodiments of the present invention may be implemented;

FIG. 9 illustrates an alternative exemplary desk support screen in an ECN support application in which embodiments of the present invention may be implemented;

FIG. 10 illustrates an alternative exemplary desk support screen having two blotter windows in an ECN support application in which embodiments of the present invention may be implemented.

### DETAILED DESCRIPTION OF THE PREFERRED EMBODIMENTS

Embodiments of the present invention relate to systems and processes for providing institutional directed sponsored trading. Systems and processes according to example embodiments of the present invention may be employed in connection with an Electronic Communication Network (“ECN”). Depending on the functionality provided by a particular ECN, a user of an ECN may be able to enter, cancel, and modify orders to buy and sell securities, display such orders to all subscribers to the system and to other buyers and sellers market-wide, view consolidated market-wide order information, and allow for the automatic matching and execution of such orders between buyers and sellers market-wide.

The systems and processes employed in connection with the ECN described below enable Institutions to designate a traditional broker as a sponsor for the Institution's trading activities that are executed on the ECN. The ECN operator may execute these orders and provide other trade-related services to the Institution. The Institution may pay commissions to the ECN operator for trade executions. The ECN operator may then report to the sponsoring brokers the identity of the designating Institutions and the sponsored trading activities executed by the ECN operator for the designating Institutions. The ECN operator may then pay a portion of the commission for the sponsored trades to the sponsoring brokers.

System Hardware Environment

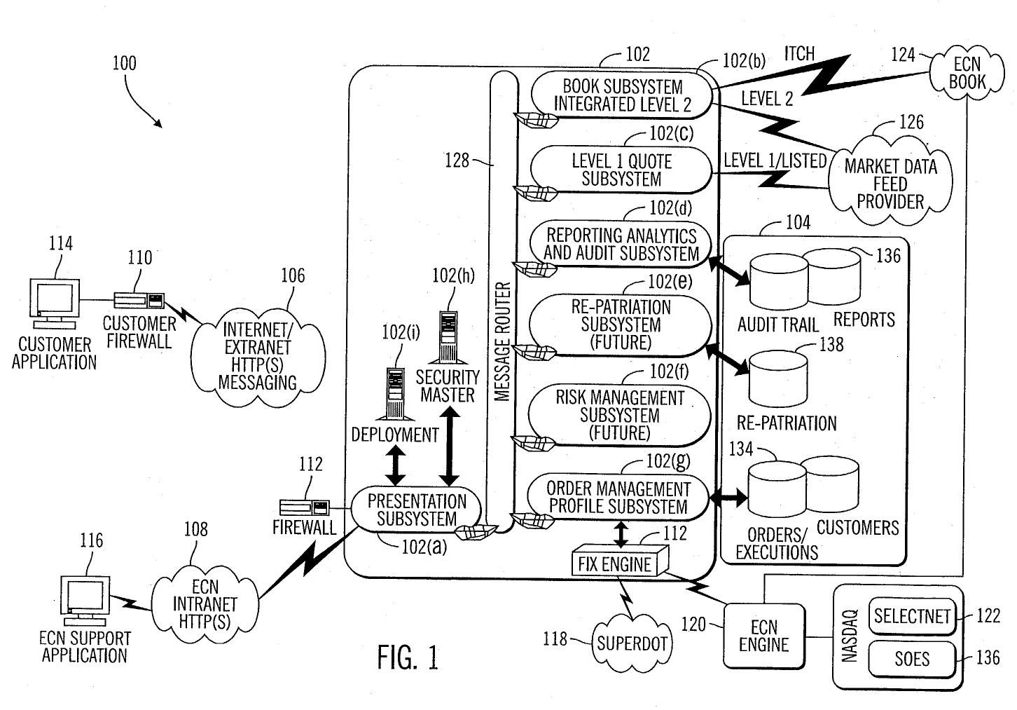

An example system hardware environment employed with embodiments of the present invention is shown in FIG. 1. FIG. 1 is a simplified view of an exemplary ECN environment 100. The ECN environment 100 may follow a scalable N-tier client-server model. The terms “client” and “server” are used to refer to a processor system's general role as a submitter of requests for data (the client) or provider of data (the server). An ECN system hardware environment is shown as an example embodiment which may be employed with embodiments of the present invention. However, any suitable ECN system for providing securities trading services may be employed with embodiments of the present invention. The ECN environment 100 comprises the following components: ECN trading application 102 (which may reside on an ECN server (not shown)), database 104, Internet/Extranet 106, ECN Intranet 108, firewalls 110 and 112, ECN client 114, ECN client 116, SuperDOT 118, ECN engine 120, SelectNet 122, Small Order Execution System (“SOES”) 136, ECN book 124, and market data feed 126.

In the embodiment described in relation to FIG. 1, access to ECN functionality may be provided, on the user end, by a Network Enabled Device (NED) such as ECN client 114 and ECN client 116. The NED may be any suitable type of computing device such as, but not limited to, desktop computers, workstations, laptops, and/or mainframe computers. The NED may comprise a modem, cable modem, Digital Subscriber Line (DSL), T-1 lines, T-3 lines, or other suitable means of connecting to a network. One or more users may be associated with each NED.

ECN trading application 102 may reside on any suitable type of computing device such as, but not limited to, desktop computers, workstations, laptops, and/or main frame computers. The ECN server on which ECN trading application 102 resides may communicate with NEDs (ECN client 114 and ECN client 116) using a protocol such as HyperText Transfer Protocol (HTTP). However, the systems and methods described in the present disclosure may be implemented in any suitable network communication protocol including, but not limited to, Transmission Control Protocol/Internet Protocol (“TCP/IP”), File Transfer Protocol (“FTP”), Wireless Application Protocol (“WAP”), and Point-to-Point Protocol (“PPP”). The client-server model is used to communicate information between the ECN server and NEDs (ECN client 114 and ECN client 116).

The ECN server on which ECN trading application 102 may reside may be coupled to a network, for example the Internet/Extranet 106 and/or the ECN Intranet 108, and may respond to document requests and/or other queries from clients such as ECN client 114 and/or ECN client 116. In other embodiments, other communication networks may be used, including, but not limited to, private networks (for example, a network provided by an Internet Service Provider (“ISP”) for its subscribers), and direct connections.

The ECN server on which ECN trading application 102 may reside may be any type of server suitable for providing such functionality. As a representative, but not limiting, example, the ECN server may comprise one or more processing units. Furthermore, the ECN server may include or operate with one or more memory devices containing data, such as database 104. Data stored in database 104 may include, but is not limited to, information about Institutions trading through the ECN, reports of transaction activities of these Institutions, sponsoring broker information, and order execution information. In other preferred embodiments, more than one ECN server may be employed, for example, for load distribution or for redundancy in the event that an ECN server fails.

ECN trading application 102 may comprise many subsystems including, but not limited to, presentation subsystem 102(a), book subsystem 102(b), quote subsystem 102(c), reporting analytics and audit subsystem 102(d), re-patriation subsystem 102(f), order management profile subsystem 102(g), security master 102(h), and deployment system 102(i).

Particular ECN trading application 102 subsystems may allow users of ECN clients such as ECN client 114 and ECN client 116 (“ECN subscribers” or Institutions) to perform various functions related to trading securities, including, but not limited to, entering, canceling, and modifying orders to buy and sell securities, displaying such orders to all ECN subscribers on the system and to other buyers and sellers market-wide, viewing consolidated market-wide order information, and may allow for the automatic matching and execution of such orders between buyers and sellers market-wide. Additionally, other ECN trading application 102 subsystems may collect and correlate information relating to Institutional directed sponsorship of trades. These subsystems may then use the information to generate reports, confirmations, statements, and/or notices, which may be sent to the Institutional customers and/or sponsoring brokers.

Furthermore, other ECN trading application 102 subsystems may track trading activities and calculate resulting commissions. These or other ECN trading application 102 subsystems may then calculate an apportionment of the resulting commissions between the ECN operator and the sponsoring broker. These subsystems, as well as other functional components of the ECN system, are discussed in more detail below and relate to the operation of the ECN system and a method for allowing institutional customers trading securities through an ECN to designate a sponsoring broker for specified trading activities.

ECN client 114, which is connected through Internet/Extranet 106 to the ECN server, may be coupled to the ECN server through a customer firewall 110, which may be located on the customer's side of the network. In addition, another firewall 112 may be located on the ECN's side of the network. Firewalls 110 and 112 may provide security by controlling access to ECN client 114 and the ECN server, respectively. In a preferred embodiment, firewalls 110 and 112 may be implemented as packet filter type firewalls which examine traffic at the network protocol packet level.

In preferred embodiments, an ECN client may access the ECN through a customer application that resides on ECN client 114, for example, a proprietary software application that a customer (“Institution”) has purchased or developed for such purpose. In the alternative, an ECN client may access the ECN through an ECN support application that resides on ECN client 116. An ECN support application may be provided to the customer to allow the customer to access the ECN through the ECN Intranet 108.

The presentation subsystem 102(a) within ECN trading application 102 determines the application platform being used by the Institution and provides the proper interface and protocols for either platform. Security master 102(h) and deployment system 102(i) may communicate with presentation subsystem 102(a). Security master 102(h) may provide information about all securities that will populate the various subsystems of ECN trading application 102. Deployment system 102(i) may provide permissioning, access rights, and version control (i.e., checks the version of the ECN support application and updates older versions).

System and device functions and processes described herein may be implemented with machine-executable instructions. Software comprising these instructions may be used to program and cause general-purpose or special-purpose processors (the ECN server processor or processors and the processor or processors within the ECN clients 114 and 116 or other NED, depending upon the function or process being performed) to perform the functions and processes described herein. Alternatively, such functions and processes may be implemented by firmware, hardware comprising hardwired logic, or by any combination thereof.

ECN System Operation

In accordance with preferred embodiments of the method disclosed herein, an Institution who wishes to trade securities may access the ECN through an ECN support application. The ECN support application may comprise a software program that provides functionality that allows the Institution to access the ECN through the ECN Intranet 108 and may comprise various screens that facilitate trading activities, including, but not limited to, entering orders to buy and sell securities, displaying such orders to all ECN subscribers and to other buyers and sellers market-wide, and automatically matching and executing such orders.

Referring again to FIG. 1, the market and order information which populates the ECN support application is provided, through the presentation subsystem 102(a) interface, by various subsystems within the ECN trading application 102. The presentation subsystem 102(a) may communicate, via message router 128, with book subsystem 102(b) and quote subsystem 102(c). Book subsystem 102(b) and quote subsystem 102(c) may provide securities information, order information, and other market data to presentation subsystem 102(a) for population of the ECN support application running on the ECN client 116. Market data may be provided to book subsystem 102(b) and quote subsystem 102(c) in real-time by a market data feed provider 126, which is a service provider that may sell market information to the ECN operator for population of the customer application and the ECN support application, or by a data feed from another market center directly. This market information may include, but is not limited to, quotes on NASDAQ or exchange listed stocks at any point in time, as well as information about the last sale of a NASDAQ or exchange listed stock and other market information.

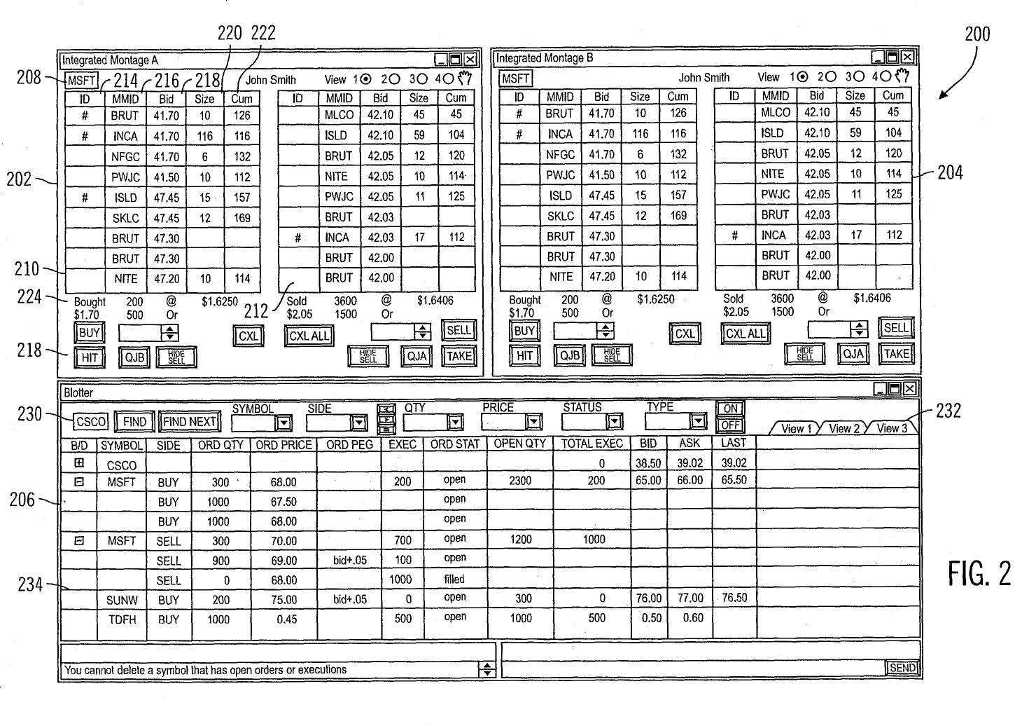

FIG. 2 illustrates an exemplary client main screen 200 displayed to the user of the ECN support application. In the present embodiment, the client main screen 200 is split into separate independent windows. Security activity windows 202 and 204 may display to the user current market information about a selected security. Blotter window 206 may display to the user information about the status of the user's current orders.

Referring first to security activity windows 202 and 204, the security which is currently selected is shown in display boxes 208 and 226, respectively. Although, in FIG. 2, the same security is selected in both security activity window 202 and security activity window 204, both windows may operate independently of one another so that information about two different securities may be displayed simultaneously, one in security activity window 202 and another in security activity window 204. In some embodiments, more than two security activity windows may be displayed simultaneously. Security activity windows 202 and 204 are functionally the same and only security activity window 202 will be described further.

Security activity window 202 is divided into a “bid” display box 210 and an “ask” display box 212. The bid price is the price at which market participants are willing to buy the selected security 208. The ask price is the price at which market participants are willing to sell the selected security 208. In the example embodiment, both the bid display box 210 and the ask display box 212 are divided into five columns.

User descriptors 214 through 222 are located at the top of their respective column. MMID descriptor 216 is located above the market participant column. The market participant column identifies which market participant (identified by a four letter acronym) is associated with the displayed bid or ask price. For example, in bid display box 210, the market participant identified by the four letter acronym PWJC is bidding 41.50 for the selected stock 208. ID descriptor 214 is located above the ECN identification column. A pound symbol (#) in this column identifies the associated market participant as an ECN.

The bid descriptor 218 (or ask descriptor in the ask display box 212) is located above the column which contains the current bid price (ask price) associated with a market participant. In keeping with the example above, the market participant identified by the stock symbol PWJC is bidding 41.50 for the selected stock 208.

The size descriptor 220 is located above the size column which contains the current size (i.e., number of shares) that the associated market participant is willing to buy (or sell). The size may be displayed in lots of 100 (i.e., a “10” in the size column indicates that the associated market participant is willing to buy (or sell) 1000 shares of the security at the associated bid (or ask) price).

The cumulative (cum) descriptor 222 is located above the column which contains an increasing cumulative total of the number of shares (in lots of 100 shares) that represents the total number of shares available in the market place at the specified price or at a better price.

Running horizontally directly beneath bid display box 210 and ask display box 212 are status lines 224 which may display to the user information including, but not limited to, cumulative information regarding the number of shares bought (or sold) and the average price per share, as well as the size and price of outstanding open orders.

Directly beneath status lines 224 is an action operator area 228. The user selectable operators and text entry boxes in action operator area 228 allow the user to perform various trading activities including, but not limited to, submitting orders to buy (or sell) a security, canceling orders to buy (or sell) a security, and canceling all orders. The user may click or otherwise select user operators within action operator area 228 (for example, by pressing a particular key combination) to perform an appropriate action. The text entry boxes allow the user to manually alter the price of outstanding open orders, and include toggle operators for incrementally increasing or decreasing the price of the order.

Referring now to blotter window 206, the security which is currently selected is shown in display box 230. As is shown in FIG. 2, the blotter window 206 may operate independently of both security activity window 202 and security activity window 204. Thus, a different security is shown selected in display box 230. Blotter window 206 may display to the user status information about current orders of the selected security. This information may include, but is not limited to, open order information, cancelled order information, and executed order information for a selected security. The information displayed for a selected security may depend on various criteria designated by the user, as discussed below.

Running horizontally along the top of blotter window 206 is a user criteria selection area 232. In preferred embodiments, the user may select various criteria for displaying the status of current orders. The various criteria may include, but is not limited to, the security symbol, side (buy or sell), quantity (number of shares), price, status (i.e., open order, cancelled order, executed order), and type (for example, “Good until the end of the day”). The criteria selection area 232 comprises text entry boxes for manually entering the criteria. In preferred embodiments, the user may have multiple blotter windows open simultaneously. In these embodiments, user selection criteria area 232 may also include multiple view tabs that the user may click or otherwise select in order to switch between blotter window displays.

Directly beneath criteria selection area 232 is blotter display box 234. In preferred embodiments, blotter display box 234 is divided into 13 columns. The 13 columns displayed in blotter display box 234 may display to the user information about the selected security based on the criteria selected in criteria selection area 232. User descriptors corresponding to the criteria are located at the top of their respective column.

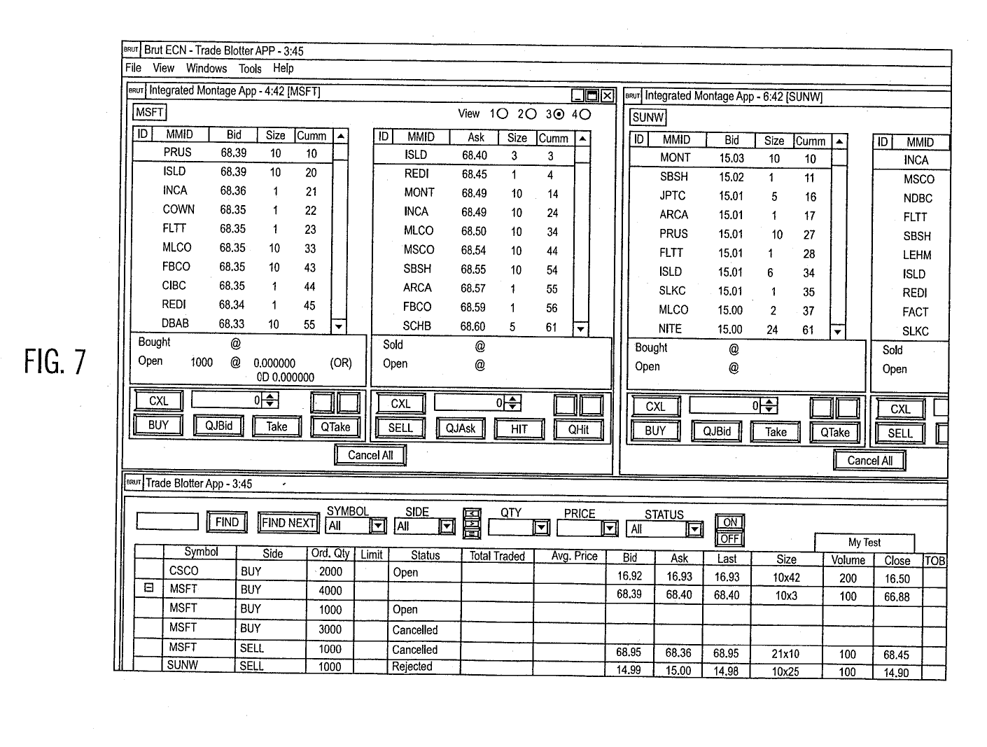

Thus, the exemplary client main screen 200 shown in FIG. 2 comprises security activity windows 202 and 204, which may display market information about user selected securities to the user and allow the user to engage in trading activities such as buying and selling securities. The exemplary client main screen 200 may also include blotter window 206, which may display to the user information about the status of the user's current orders. FIG. 7 shows an alternative exemplary client main screen in an ECN support application in which embodiments of the present invention may be implemented.

In preferred embodiments, an Institution using the ECN support application to access the ECN may be offered customer support services by the ECN operator. These customer support services may be integrated into the customer support application and may allow an ECN operator computer (or other NED) to communicate with a particular trader's client computer (or other NED) so that an ECN customer support representative operating the ECN operator computer may view information that the trader is currently viewing in the client main screen (for example, client main screen 200 in FIG. 2) on the trader's client computer. The customer support representative or other ECN operator representative may access information about a particular Institution (or trader within the Institution) from the ECN operator computer through use of a desk support function integrated into the ECN support application, as discussed below.

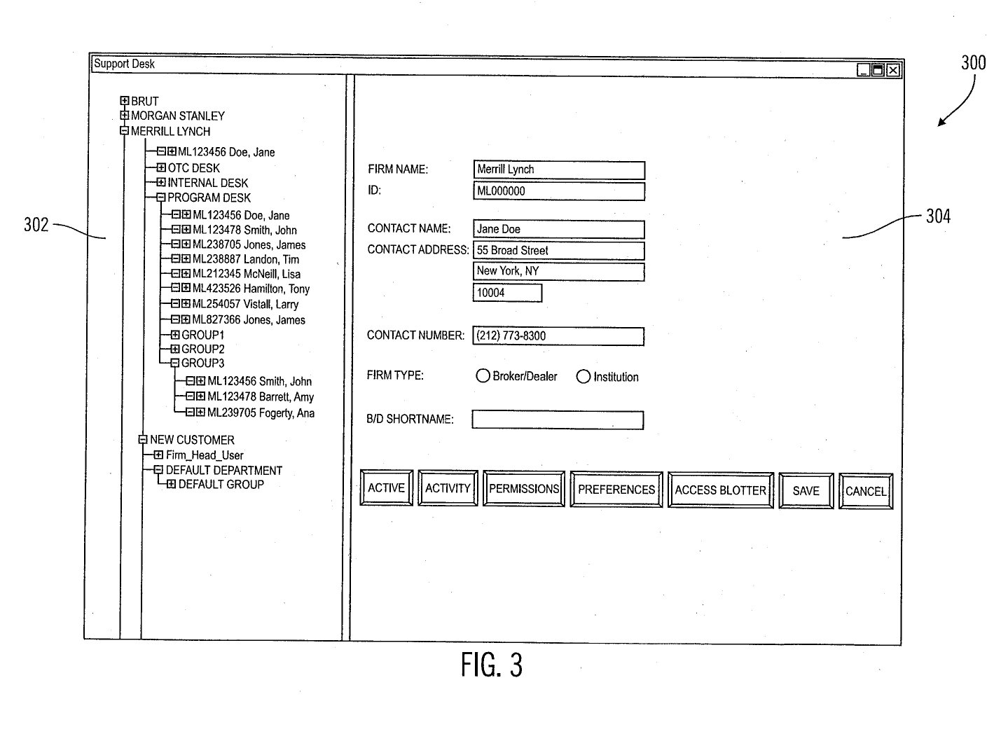

FIG. 3 depicts an exemplary desk support main screen 300 in the ECN support application. The desk support main screen 300 is utilized by an ECN operator customer support representative to provide customer support to the ECN subscribers. In the present embodiment, the desk support main screen 300 is split vertically into two separate windows. The first window, customer tree window 302, may display a hierarchical tree structure view of the ECN subscribers. The second window, contact box 304, may display contact information about particular traders as well as user selectable action operators that perform various functions related to the particular trader's trading activities on the ECN.

Referring first to the customer tree window 302, the tree structure may be collapsed or expanded by clicking or otherwise selecting the “+” or “−” symbols adjacent to the name of the ECN subscriber. As an example, as shown in customer tree window 302 in FIG. 3, an ECN subscriber (“MERRILL LYNCH”) is shown after the + sign has been clicked. The expanded tree structure associated with MERRILL LYNCH may comprise subgroups, which may be further expanded or collapsed (for example, “PROGRAM DESK”), and individual traders associated with a subgroup which may be viewed by expanding the particular subgroup.

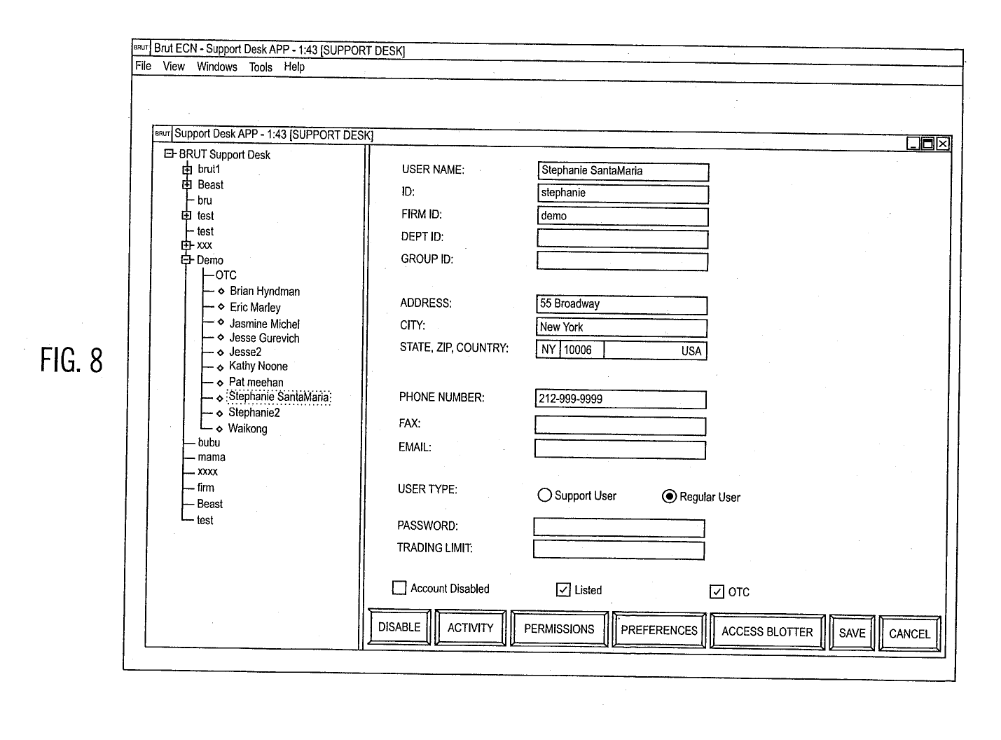

Referring now to contact box 304, contact information is displayed for “Jane Doe,” a particular trader at the Program Desk of Merrill Lynch. The contact information displayed may include, but is not limited to, firm (ECN subscriber) name, identification number, contact name, contact address, contact phone number, firm type (i.e., broker dealer or Institution). In addition to the contact information, contact box 304 further displays user selectable operators that provide functionality in relation to the displayed contact. FIG. 8 shows an alternative exemplary desk support main screen in an ECN support application in which embodiments of the present invention may be implemented.

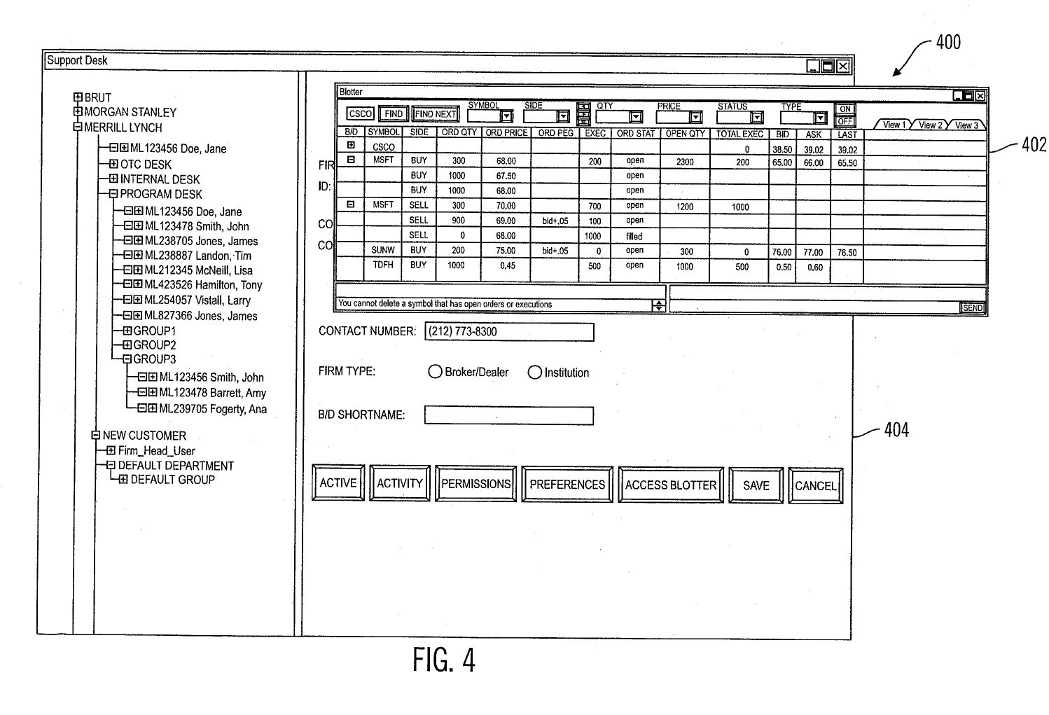

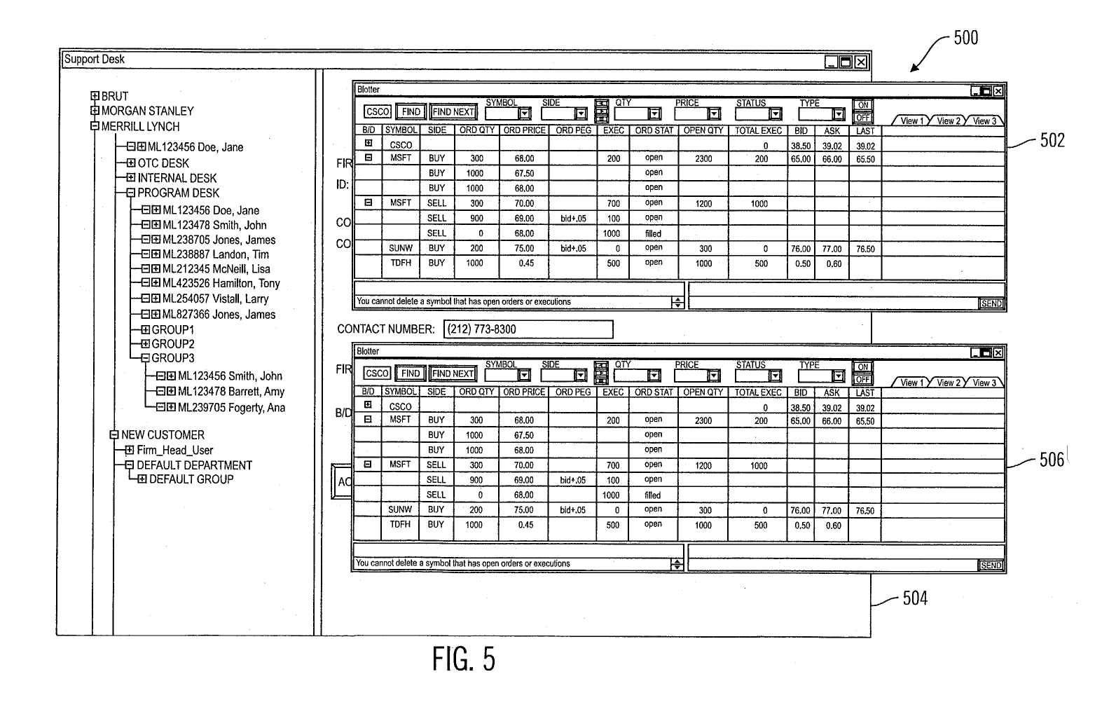

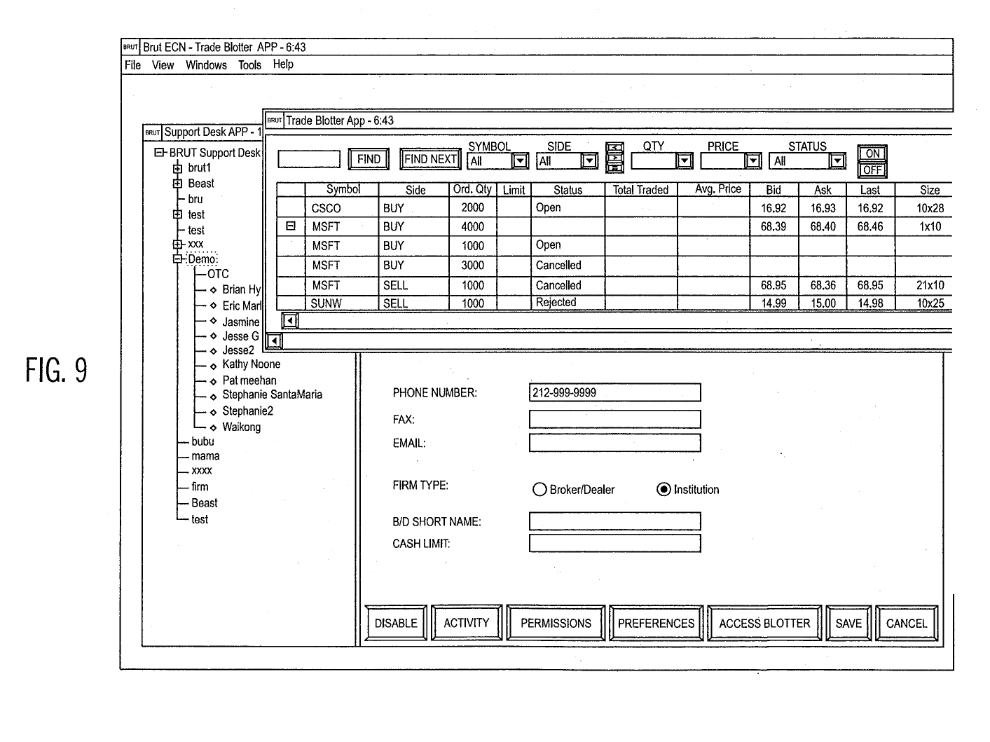

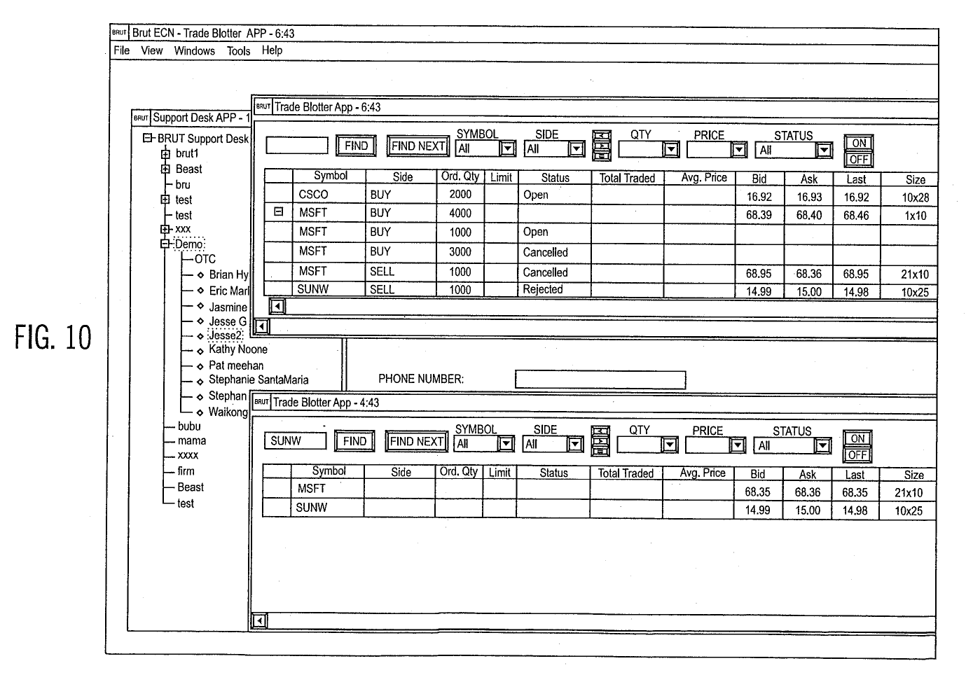

As an example, an “access blotter” user selectable operator may be included which, when selected, displays on an ECN operator's customer support computer screen the blotter window visible on the presently displayed trader's computer (or other NED) screen, as shown in FIG. 4. FIG. 4 shows desk support screen 400. Blotter window 402 is displayed, on the ECN client 116, to the trader whose information is currently displayed in the contact box 404. Blotter window 402 is simultaneously displayed to the customer support representative on the ECN operator's computer screen. Access to the particular trader's blotter window by the customer support representative may facilitate provision of customer support services by the ECN operator by displaying to the representative real-time information about the current status of the particular trader's trading activities. FIG. 9 shows an alternative exemplary desk support screen in an ECN support application in which embodiments of the present invention may be implemented. In preferred embodiments, multiple blotter windows of a particular trader may be viewed by the representative, as shown in FIG. 5. FIG. 5 shows two blotter windows, blotter windows 502 and 506, both being active blotter windows of the particular trader shown in contact box 504. FIG. 10 shows an alternative exemplary desk support screen having two blotter windows in an ECN support application in which embodiments of the present invention may be implemented.

Institutional Directed Sponsored Trading

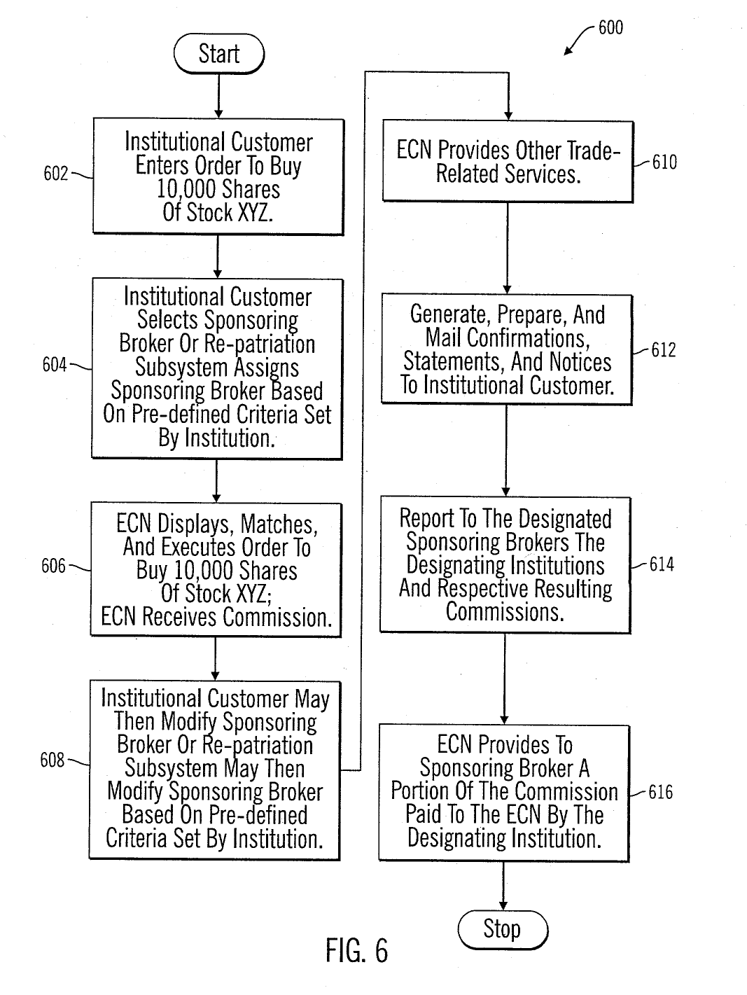

FIG. 6 shows a flowchart of a process for allowing institutional customers trading securities through an ECN to designate a sponsoring broker for specified trading activities. The process will now be described in detail with reference to FIG. 1, FIG. 2, and FIG. 6.

In preferred embodiments, the Institution using the ECN support application may enter a desired order, as shown in step 602. As an example, the Institution may enter an order to buy (or sell) 10,000 shares of stock XYZ by manually entering the stock's acronym (XYZ) into display box 208, shown in FIG. 2. The bid and ask prices of XYZ stock may then be displayed in security activity window 202 along with the associated market participants, as discussed above. The text entry boxes located in the action operator area 228 allow the user to manually alter the price of outstanding open orders, and include toggle operators for incrementally increasing or decreasing the price of the order text box.

In a preferred embodiment, a list of third party brokers associated with the ECN may then be displayed within client main screen 200. The Institution may be given the opportunity to select a sponsoring broker from this list for the XYZ trade, as shown in step 604. In other embodiments, the Institution may be presented with the list and asked to select a sponsoring broker upon first connecting to the ECN. In this embodiment, the selected sponsoring broker may be the sponsoring broker for all trading activities performed by the Institution in that trading day.

In further embodiments, the Institution may be able to select one sponsoring broker for selling securities and another sponsoring broker for buying securities. In yet other embodiments, the Institution may select a sponsoring broker for particular securities. As an example, if the Institution believes that an analyst employed by a broker associated with the ECN is particularly insightful with regard to XYZ stock, the Institution may select the broker employing the analyst as the sponsoring broker for all trade orders for XYZ stock entered by the Institution.

In yet other embodiments, the Institution may allocate a certain percentage of its trades to one sponsoring broker and the remaining percentage may be allocated to one or more additional sponsoring brokers. In yet other embodiments, the Institution may allocate a certain dollar amount in commissions to a first sponsoring broker and the remainder to other sponsoring brokers. For example, the Institution may allocate the first 10,000 dollars in commissions to the first sponsoring broker and the remainder to a second sponsoring broker.

In addition, the Institution may be able to select a “good until changed” user-selectable operator that may be displayed on client main screen 200, which may allow the Institution to keep the same sponsoring broker for pre-defined trading activities (such as the buying and/or selling of a particular stock) until the Institution designates a different sponsoring broker for those trading activities. For example, if the Institution designates a particular broker to sponsor all trades of XYZ stock and selects the “good until changed” operator, then any trades that are made in that stock by the Institution may be sponsored by the selected broker until the Institution specifically designates another broker to sponsor those trades in that stock.

Information about Institutional sponsorship may be compiled utilizing the repatriation subsystem 102(e) of ECN trading application 102. The repatriation subsystem 102(e) may communicate, via message router 128, with the presentation subsystem 102(a). As sponsors are designated by Institutions, information about the Institutional sponsorship may be generated by the re-patriation subsystem 102(e) and stored in repatriation storage unit 138 within database 104. This information allows the ECN to track Institution sponsors and forms the basis of reports provided to the sponsoring brokers regarding their sponsorship of particular Institutions. The repatriation subsystem 102(e) may also automatically allocate the Institution's trades to sponsoring brokers based on the Institution's pre-defined criteria (for example, percentage allocation) as the Institution's orders flow into the ECN.

Once the sponsoring broker has been selected and the order is entered, the order may be routed, in the form of an “order message,” thorough the presentation subsystem 102(a) into the message router 128, where the order message may be delivered to the order management profile subsystem 102(g). If the security involved is a listed stock, then the order management profile subsystem 102(g) may then route the order message to the NYSE through the Financial Information Exchange (“FIX”) engine 132, where the order message will be converted into a message format compatible with the FIX protocol (an electronic messaging protocol used in the financial industry). The message will then be routed to SuperDOT 118 and on to the NYSE.

If the security involved is not a listed stock, then the order management profile subsystem 102(g) may route the order message to the FIX engine 132, where the order message will be converted into a message format compatible with the FIX protocol. The order message may then be routed to the ECN engine 120, which may comprise the ECN data manipulation functions and procedures (i.e., the back end of the ECN).

From the ECN engine 120, the order message may then be routed, based on preset routing criteria within the engine, to different destinations. If there is market interest in the order, the order message may be routed to NASDAQ, via SelectNet 122 (NASDAQ automated order routing mechanism) or SOES 136 (NASDAQ automatic execution system). To the extent that there is no market interest in the order at the present time, the order message may be routed to the ECN book 124, which may then display the order, through book subsystem 102(b) and presentation subsystem 102(a), on client main screen 200 in order that other ECN subscribers may execute against the order. In addition, information about the order may be stored on order/execution storage unit 134 within database 104.

As discussed above and as shown in step 606, the ECN may display the order to other ECN subscribers, as well as other buyers and sellers market-wide, and allow for the automatic matching of a “buy order” of XYZ stock to a “sell order” of XYZ stock entered by another buyer or seller. If such a match is found, the ECN may automatically execute the order. The ECN may then collect a commission for the trade from the Institution. For example, assuming that the ECN charges a base rate of $50.00 to execute a trade, plus an additional 3 cents per share for every share traded, if the Institution purchased 10,000 shares of XYZ stock, the commission on that trade would be $50.00+(0.03×10,000)=$350.00. The Institution may then remit this sum to the ECN operator.

The Institution may be given the opportunity to modify its choice of a sponsoring broker during the course of, or at the close, of the trading day, as shown in step 608. In other embodiments, the modification may be made automatically by the repatriation subsystem 102(e) of the ECN trading application 102 during the course of, or at the close of the trading day, as shown in step 608, based on pre-defined criteria set by the Institution.

As shown in step 610, in some embodiments, in addition to the trade execution services described above, the ECN may provide, or cause to be provided (for example, through a clearing broker), to the Institution other services that were traditionally provided by brokers, such as receipt, delivery, and transfer of securities purchased or sold, receipt and distribution of payment therefore, receipt and distribution of any interest or dividend payments or other distributions associated with such securities, and, to the extent required, holding in custody and safekeeping any such securities and cash so received. Furthermore, the ECN may maintain books, records, and account documentation of all trading activities and other transactions performed through the ECN by a particular Institution.

The above information may be compiled utilizing various subsystems of ECN trading application 102. For example, as discussed above, order information may be stored on order/execution storage unit 134. In addition, reporting analytics and audit subsystem 102(d) may communicate, via message router 128, with the presentation subsystem 102(a). Information about trading activities of ECN subscribers is generated by the reporting analytics and audit subsystem 102(d) and stored in audit trail and reports storage unit 136 within database 104. This information forms the basis of reports provided to the Institutions by the ECN operator.

As shown in step 612, in preferred embodiments, the ECN may periodically generate, prepare, and mail, or cause to be generated, prepared, and mailed, directly to the Institution, confirmations, statements, and notices respecting the trading activities and other transactions performed through the ECN by the Institution. These confirmations, statements, and notices may contain a confirmation of a particular trade, showing the ECN operator as the executing entity for the trade. In preferred embodiments, in addition to showing the ECN as the executing entity, the sponsoring broker associated with a particular trade may also be reflected in the confirmation. For example, a phrase may be printed in proximity to the printed trade confirmation stating: “Courtesy of [Sponsoring Broker],” in confirmation of the Institution's designation of the sponsoring broker for that particular trade.

In a preferred embodiment, the sponsoring broker may obtain a copy of these confirmations, statements, and notices by requesting them from the ECN, provided the Institution receives written notification of the request. In this embodiment, the sponsoring broker may maintain communication with the Institution, for example, by responding directly to the Institution's comments or questions.

As shown in step 614, in preferred embodiments, the ECN may provide to a sponsoring broker a portion of the commission paid to the ECN by the Institution for trading activities for which the Institution designated the broker as a sponsor. For example, in keeping with the example above, the broker designated as the sponsoring broker for the purchase of the 10,000 shares of XYZ stock may receive a portion of the $350.00 commission. In preferred embodiments, the commission may be apportioned according to an established agreement between the ECN operator and the broker.

As shown in step 616, in preferred embodiments, the ECN may periodically report to the designated sponsoring brokers the designating Institutions and respective resulting commissions. This reporting function facilitates the sponsoring broker in tracking commission activity of particular Institutions and providing to the designating Institutions, in return, non trade-related services commensurate with the commission activity. In a preferred embodiment, these reports may be sent to the designated sponsoring brokers on a monthly basis. As discussed above, information about Institutional sponsorship of trading activity may be generated by the re-patriation subsystem 102(e) and stored in repatriation storage unit 138 within database 104. This information may allow the ECN to track Institution sponsors, determine proper commission allocation, and generate reports to the sponsoring brokers.

Finally, in some embodiments, a risk management subsystem 102(f) may additionally be included in ECN trading application 102 for calculating an Institution's exposure to market risk based on risk parameters that the Institution may designate. For example, an Institution may wish to know the risk of their overall market exposure, the market exposure for a particular sector of the market, or for a particular security. If an Institution desires such information, orders entered by the Institution may be routed to the risk management subsystem 102(f), which may communicate with the presentation subsystem 102(a) through the message router 128. The risk management subsystem 102(f) may then calculate the risk exposure for the Institution based on the designated risk parameters. A risk report may then be communicated back to the Institution via the message router 128 and the presentation subsystem 102(a).

Various embodiments of the present invention may include one or more of the features, screens, displays, and functions described above. One example embodiment includes all the features, screens, displays, and functions described above.

Therefore, systems and methods for providing institutional directed sponsored trading have been described. In a preferred embodiment, an Institution who wishes to trade securities may connect to the ECN through a network interface. The Institution may then enter orders to buy and sell securities, display such orders to all subscribers to the system and to other buyers and sellers market-wide, and automatically match and execute the orders. The Institution may designate a broker to sponsor a particular trade or group of trades.

The execution of these orders and other trade-related services may be provided to the Institution by the ECN operator. The Institution may pay commissions to the ECN operator for trade executions. The ECN operator may then report to the sponsoring brokers the identity of the designating Institutions and the sponsored trading activities executed by the ECN operator for the designating Institutions. The ECN operator may pay a portion of the commission for the sponsored trades to the sponsoring brokers.

It is to be understood that even though numerous characteristics and advantages of various embodiments of the present invention have been set forth in the foregoing description, together with details of the structure and function of various embodiments of the invention, this disclosure is illustrative only. Changes may be made in detail, especially matters of structure and management of parts within the principles of the present invention to the full extent indicated by the broad general meaning of the terms in which the appended claims are expressed.

Having disclosed exemplary embodiments and the best mode, modifications and variations may be made to the disclosed embodiments while remaining within the scope of the invention as defined by the following claims.

What is claimed is:

1. A process for providing sponsorship of trading activity by an Institution on an Electronic Communication Network, the process comprising:
providing to the Institution access to the Electronic Communication Network;
receiving from the Institution a specification of a trade to be executed;
receiving from the Institution a designation of a third party as a sponsor for the specified trade; and
executing the specified trade.

2. The process recited in claim 1, wherein providing access to the Institution to the Electronic Communication Network comprises providing access to the Electronic Communication Network through a network interface through which the Institution may specify the trade to be executed without assistance from the third party.

3. The process recited in claim 1, wherein receiving from the Institution a designation of a third party as a sponsor for the specified trade comprises receiving from the Institution a designation of a broker as the sponsor for the specified trade.

4. The process recited in claim 3, wherein receiving from the Institution a designation of a broker as a sponsor for the specified trade further comprises facilitating provision of at least one non-trade related service by the broker to the Institution, in return for designation as the sponsor for the specified trade.

5. The process recited in claim 4, wherein facilitating provision of at least one non-trade related service to the Institution comprises facilitating provision of at least one non-trade related service selected from the group consisting essentially of asset servicing, opportunity to participate in initial public offerings, custodial services, and research.

6. The process recited in claim 3, wherein receiving from the Institution a designation of a broker as the sponsor for the specified trade comprises receiving from the Institution a designation of the broker as the sponsor for all trades executed on a specified trading day.

7. The process recited in claim 3, wherein receiving from the Institution a designation of a broker as the sponsor for the specified trade comprises receiving from the Institution a designation of the broker as the sponsor for all trades in a specified security.

8. The process recited in claim 3, wherein receiving from the Institution a designation of a broker as the sponsor for the specified trade comprises receiving from the Institution a designation of the broker as the sponsor for a specified percentage of trades executed on a specified trading day.

9. The process recited in claim 1, wherein executing the specified trade comprises matching orders between buyers and sellers and effecting a matched order.

10. The process recited in claim 1, further comprising:
receiving remuneration from the Institution for executing the specified trade; and
providing sponsorship credit to the designated third party.

11. The process recited in claim 10, wherein receiving remuneration from the Institution for executing the specified trade comprises receiving a commission from the Institution for executing the specified trade.

12. The process recited in claim 10, wherein providing sponsorship credit to the third party comprises providing a portion of the received commission to the third party.

13. The process recited in claim 12, wherein the Institution designates the third party as the sponsor for a number of trades executed on a specified trading day, the number of trades corresponding to a specified commission amount.

14. The process recited in claim 1, further comprising:
recording the sponsor designations made by the Institutions; and
reporting the designating Institution to the designated third party.

15. The process recited in claim 1, further comprising:
tracking the Institution's trades that are sponsored by the designated third party; and
reporting the Institution's trades to the designated third party.

16. The process recited in claim 14, wherein reporting the designating Institution to the designated third party comprises reporting the designating Institution to the designated third party periodically.

17. The process recited in claim 15, wherein reporting the trades to the designated third party comprises reporting to the designated third party a number of shares traded.

18. The process recited in claim 15, wherein reporting the trades to the designated third party comprises reporting the trades to the designated third party periodically.

19. The process recited in claim 1, further comprising:
assisting the designated third party in providing at least one non-trade related service to the designating Institution in return for designation as the sponsor for the specified trade.

20. The process recited in claim 19, wherein assisting the designated third party in providing at least one non-trade related service to the designating Institution comprises providing information to the designated third party about the designating Institution's specified trades.

21. The process recited in claim 19, wherein assisting the designated third party in providing at least one non-trade related service to the designating Institution comprises assisting the designated third party to provide at least one non-trade related service selected from the group consisting essentially of asset servicing, opportunity to participate in initial public offerings, custodial services, and research.

22. An Electronic Communication Network system, comprising:
a client network enabled device communicating with the Electronic Communication Network;
an Electronic Communication Network server communicating with the network enabled device;
an Electronic Communication Network support application residing on the network enabled device for interfacing with the Electronic Communication Network, the Electronic Communication Network support application comprising user selectable operators that enable an Institution to designate a third party as an Institutional sponsor for specified trading activities; and
an Electronic Communication Network trading application residing on the Electronic Communication Network server, the Electronic Communication Network trading application comprising a subsystem for generating information associating the Institution's designated third party with specified trading activities.

23. The system recited in claim 22, further comprising:
a database for storing the association information; and
an Electronic Communication Network trading application subsystem for generating first and second reports based on the association information.

24. The system recited in claim 22, further comprising:
a database for storing Institutional information; and
an Electronic Communication Network trading application subsystem for directing the first report to the Institution based on the Institutional information.

25. The system recited in claim 22, further comprising:
a database for storing designated third party information; and
an Electronic Communication Network trading application subsystem for directing the second report to the designated third party based on the designated third party information.

26. The system recited in claim 22, further comprising:
an Electronic Communication Network trading application subsystem for automatically allocating a portion of the Institution's trading activities to the designated third party based on criteria pre-defined by the Institution.

27. The system recited in claim 22, wherein the Electronic Communication Network trading application subsystem includes in the first report a confirmation of the designated third party.

28. The system recited in claim 22, wherein the Electronic Communication Network trading application subsystem includes in the second report information about the designating Institution and the specified trading activities.

29. An Electronics Communication Network support application residing on a Network Enabled Device for interfacing with an Electronic Communication Network server, the Electronic Communication Network support application comprising:
display boxes for displaying a list of third parties associated with the Electronic Communication Network; and
user selectable operators for designating at least one of the third parties as a sponsor for specified trading activities.

30. The Electronic Communication Network support application recited in claim 29, further comprising user selectable operators for selecting a time period for which the third party will act as the sponsor.

31. The Electronic Communication Network support application recited in claim 30, wherein the time period is one trading day.

32. The Electronic Communication Network support application recited in claim 29, further comprising user selectable operators for specifying a particular security for which the third party will act as the sponsor.

33. The Electronic Communication Network support application recited in claim 29, further comprising user selectable operators for specifying a particular trading activity for which the third party will act as the sponsor.

34. The Electronic Communication Network support application recited in claim 33, wherein the particular trading activity is buying securities.

35. The Electronic Communication Network support application recited in claim 33, wherein the particular trading activity is selling securities.
